(19) United States
(12) Patent Application Publication
(10) Pub. No.: US 2008/0169156 A1
(43) Pub. Date: Jul. 17, 2008

(54) Hunter tree stand

(75) Inventors: Jay Grant Leishman, Paradise, UT (US); Daniel Max Kropf, Providence, UT (US)

Correspondence Address: HOLME ROBERTS & OWEN, LLP, 299 SOUTH MAIN, SUITE 1800, SALT LAKE CITY, UT, 84111, US

(73) Assignee: Northern Valley Fabrication, Inc., North Logan, UT (US)

(21) Appl. No.: 11/653,519

(22) Filed: Jan. 16, 2007

(51) Int. Cl. A01M 31/02

(52) U.S. Cl. 182/187

(57) ABSTRACT

A tree stand attaches to a tree trunk for a hunter to sit in. The tree stand includes a seat structure shaped to provide support for a user. The seat structure has a frame. An attachment device is configured to anchor to the tree trunk and to support the weight of a user positioned in the tree stand. A first pivot structure is attached between the seat structure and the attachment device. The first pivot structure is connected to the frame and cantilevered out from the first pivot structure. The first pivot structure has a first axis about which the seat structure rotates thru a first range of motion. The first range of motion is a side to side movement around the tree trunk.

### BACKGROUND OF THE INVENTION

1. The Field of the Invention

The present invention relates to a hunter tree stand and, more particularly, to a portable tree stand that provides a seat for hunters.

2. State of the Art

Hunters use tree stands to provide an elevated perch to see potential game at a greater distance and over the top of lower vegetation. Tree stands also hide the hunters by placing them outside the normal view of the game's watchful eyes and up towards the tree branches or foliage. Conventional tree stands are generally attached to a tree trunk by straps, cables, or other types of clamping devices. Some tree stands are more permanent. For example, some tree stands are partially or fully supported from the ground using legs or ladders. Others are permanently attached to the tree trunk using cleats, nails, pins, or stakes.

The tree stands typically include a seat or platform to stand on, or a combination of both. The seat gives the hunter a place to rest while waiting for game to walk by the hunter's position. The seat can be arranged to face the hunter towards or away from the tree trunk. If the hunter misses the targeted game, he or she may desire to follow the game or relocate to another position. Some tree stands are disadvantageous because they are harder to move around or pack into the game area. Other tree stands are difficult to set up and take down due to the size and collapsibility of the device.

A variety of lightweight, portable tree stands have been developed to allow hunters to carry and readily move them from place to place. Some examples provide two flat platforms—one for the hunter's feet and one to sit on. The platforms are spaced apart from each other and attached to the tree truck using straps that encircle the trunk at one end and tension arms that support the outer ends of the platforms. Some have backrests and others are arranged to use the tree trunk as a backrest. These two platforms can be placed against each other to reduce the volume of the tree stand when toting the tree stand around. In these examples, the hunter is limited to the range of sight and movement by the position in which the tree stand was fixed to the trunk.

In another example, a chair or seat is suspended from the tree. The chair is anchored to the tree above the hunter and is suspended by webbing or straps. A foot stand can be attached below the chair to give the hunter added support. Since the chair is free to move about the trunk, the hunter is strapped to it with a harness. The suspended chair has more movement than the fixed stands, but is limited by the hunter's ability to get in and out of the chair.

### BRIEF SUMMARY OF THE INVENTION

A tree stand attaches to a tree trunk for a hunter to sit in. The tree stand includes a seat structure shaped to provide support for a user. The seat structure has a frame. An attachment device is configured to anchor to the tree trunk and to support the weight of a user positioned in the tree stand. A first pivot structure is attached between the seat structure and the attachment device. The first pivot structure is connected to the frame and cantilevered out from the first pivot structure. The first pivot structure has a first axis about which the seat structure rotates thru a first range of motion. The first range of motion is a side to side movement around the tree trunk.

In another aspect of the invention, a hunter tree stand includes a seat structure shaped to provide support for a user. The seat structure has a frame. The seat structure is moveable between a use position wherein the user can sit in the seat structure and a storage position wherein the user can tote the tree stand. An attachment device is configured to anchor the tree stand to a tree trunk and to support the weight of the user positioned in the tree stand. A first pivot structure is attached between the seat structure and the attachment device. The first pivot structure is attached to the frame and has a first axis about which the seat structure rotates thru a first range of motion. The first range of motion ranges between a first point where one side of the seat structure touches the tree trunk to a second point where another side of the seat structure touches the tree trunk.

These and other features of the present invention will become more fully apparent from the following description, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a tree stand in accordance with the present invention illustrating a use position, and a first and second range of motion;

FIG. 2 is a perspective view of the tree stand in accordance with the present invention illustrating a storage position;

FIG. 3 is a partial assembly view of the tree stand and illustrates a third range of motion;

FIG. 4 is detailed view of the tree stand illustrating the second range of motion; and

FIG. 5 is a top view of the tree stand further illustrating the first range of motion.

### DETAILED DESCRIPTION OF THE EXEMPLARY EMBODIMENTS

Reference will now be made in detail to the exemplary embodiments of the present invention, examples of which are illustrated in the accompanying drawings. The various exemplary embodiments provide a hunter tree stand.

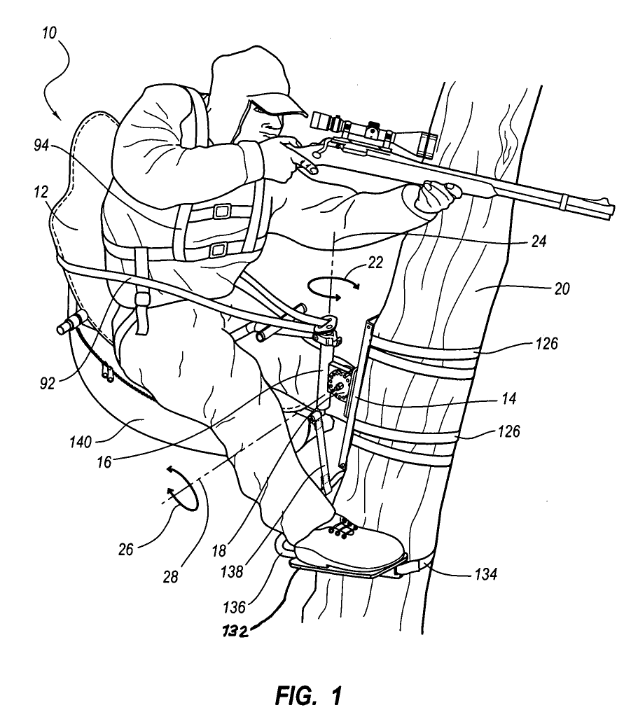

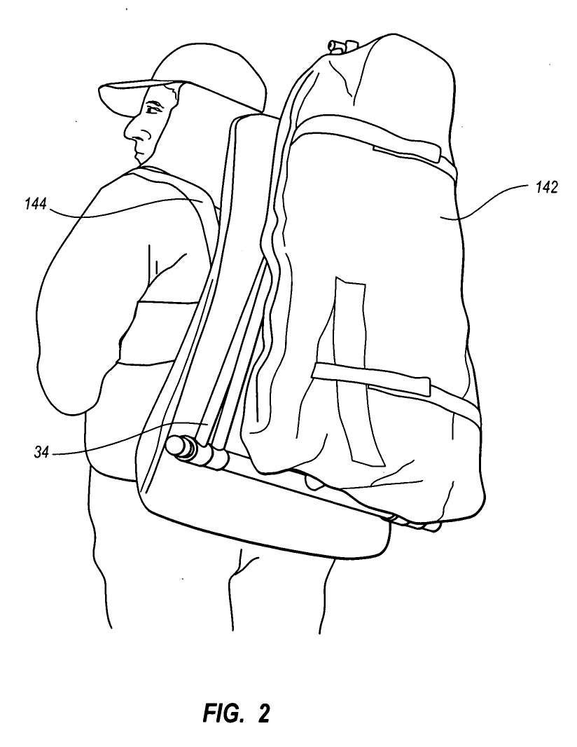

A tree stand 10 is illustrated in FIGS. 1-5 in accordance with the various embodiments of the present invention. The tree stand 10 is designed to be portable, collapsible, and to provide a wide range of motion once fixed to a tree. The tree stand 10 can be placed in a use position as shown in FIG. 1 or be collapsed into a storage position as shown in FIG. 2. While in the use position, the tree stand 10 can be rotated about a tree. In the storage position, the user can store or tote the tree stand 10 as desired.

The tree stand 10 has many benefits and advantages. For example, it is made to be quick and easy to set-up and take down. The tree stand includes components that pivot and collapse to allow the user to place it in a backpack arrangement. In addition, the tree stand is very versatile in the use position. For instance, the user can rotate the tree stand 10 about the tree to gain a better view around the tree. The tree stand also can be reclined or plumbed to provide additional comfort to the user.

The user can install the tree stand 10 on almost any tree that is large enough to support his or her weight. The tree is not required to be limbless or straight. Hunters can waste time trying to locate the perfect tree that is located in the perfect location. The tree stand 10 of the present invention is more versatile than the conventional tree stands in the market.

In another aspect of the invention, a storage compartment can be attached under the user's seat. Supplies can be stored in the storage compartment. In this manner, the user has easy access to supplies. The storage compartment can also be used to enclose all or part of the tree stand 10. For example, the tree stand 10 can be carried in a backpack-like structure. The backpack-like structure can provide a means to carry the tree stand 10 as well as a means for providing the storage compartment. In the storage position, the tree stand 10 is easily packed in and out of desired locations.

As shown in FIG. 1, the tree stand 10 includes a seat structure 12, an attachment device 14, and a first and second pivot structure 16, 18 positioned between the seat structure 12 and the attachment device 14. The attachment device 14 is design to attach to a tree trunk 20, be adjusted along the tree trunk, and be removed from or reattached to the tree trunk 20. One end of the attachment device 14 is attached to the tree trunk 20. Another end of the attachment device 14 is connected to the seat structure 12. The first pivot structure 16 is positioned between the attachment device 14 and the seat structure 12. The first pivot structure 16 provides a first range of motion 22 from side to side around the tree trunk 20. The first pivot structure 16 includes a first axis 24 about which the seat structure 12 rotates thru the first range of motion 22. The first pivot structure 16 provides movement in a single plane. For example, the first pivot structure 16 can pivot the seat structure 12 about a point around the tree trunk 20 from a point where the seat structure 12 touches the tree trunk 20 on one side to a point where the seat structure 12 touches the tree trunk 20 on its other side, where the typical resting position would be somewhere in between. The first axis 24 is found in a line that is relative to the length of the tree trunk 20.

The second pivot structure 18 is also positioned between the attachment device 14 and the seat structure 12. The second pivot structure 18 provides a second range of motion 26 to plumb the first axis 24. The second pivot structure 18 includes a second axis 28 about which the seat structure 12 rotates thru the second range of motion. For example, the second pivot structure 18 can rotate the seat structure 12 between a recline position and an upright position. The second axis 28 can be substantially perpendicular to the first axis 24. The meaning of substantially perpendicular within this description is meant to be about 85 to 95 degrees relative to another point of reference, and more preferably at about 90 degrees. Substantially parallel is defined as parallel within a tolerance of about ±5 degrees. The first axis 24 is designed to provide a different motion than the second axis 28 to allow the user to plumb or recline the first axis 24.

To install the tree stand 10, the user selects a tree in a desired location, trunk thickness, and branch clearance. A desired height on the tree trunk is selected. Branches and debris can be cleared from the desired height if needed. The user then climbs the tree within reach of the desired height and places the tree stand 10 up against the tree trunk 20. The attachment device 14 is attached to the tree trunk 20 and the seat structure 12 is folded out into a use position.

The seat structure 12 is designed to support the forces and stresses that are applied by a user sitting in the tree stand 10. The seat structure 12 is attached to the attachment device 14. The seat structure 12 includes a cushion 30 and backing 32. The cushion 30 is attached to the backing 32. The backing 32 can be rigid, semi-rigid, or otherwise provide support for the user to sit in the seat structure 12. For example, the backing can be made of a cloth weave, metal component, composite, or plastic material, such as polyethylene, polyurethane, polypropylene, nylon, or vinyl. All or portions of the backing 32 can be flexible to allow the user to fold-up the cushion 30 with the backing 32. The cushion 30 is made of a soft material such as foam, fiber, gel, or other like material used by those skilled in the art to provide a cushion.

The cushion 30 and backing 32 is attached to a frame 34. The frame 34 includes a seat portion 36 and a back portion 38, the seat portion 36 being connected to the back portion 38. The cushion 30 being designed to overlay the seat portion 36 and the back portion 38. The frame 34 can be collapsible by providing a back portion 38 that collapses against the seat portion 36. The collapsible function will be discussed in further detail below.

The frame 34 can be made of a rigid material, such as a metal or plastic and can be formed from tubes, bars, or other structural members. The seat portion 36 is sized and shaped to provide adequate support for the user to sit in the seat structure 12. The back portion 38 is sized and shaped to provide back support for the user. For instance, the seat portion 36 and back portion 38 can have a rectangular, triangular, or curved shape that is sized to fit the width of the hips and back of an average-sized user.

A third pivot structure 40 is located between the seat portion 36 and the back portion 38. The third pivot structure 40 provides a third range of motion 42 to collapse the back portion 38 against the seat portion 36. The third pivot structure 40 includes a third axis 44 about which the back portion 38 rotates thru the third range of motion 42. For example, the third pivot structure 40 can rotate the back portion 38 between a collapsed position where the back portion 38 pivots towards and folds up against the seat portion 36 and a support position where the back portion 38 is extended up and away from the seat portion 36 at a desired angle. The desired angle between the seat portion 36 and the back portion 38 in the support position can be set by restricting rotational movement beyond a certain point. For example, the desired angle in the support position can be set to place the back portion 38 at about 90 degrees to about 180 degrees relative to the seat portion, and more specifically, the desired angle can be set between about a range of 100 degrees to about 130 degrees. A stop 46 can be used on one or both sides of the seat portion 36 or back portion 38 to restrict the movement, such as a set screw, plate, spring plunger, pin, or other structure known by one skilled in the art that can be used to restrict rotational movement.

The third axis 44 is substantially perpendicular to the first axis 24 or substantially parallel to the second axis 28. The third pivot structure 40, for example, can be a shaft that rotates within a pipe, sleeve, bearings or bushings that are arranged to rotate with respect to a shaft, or a ratchet or indexed system that is arranged to intermittently rotate the back portion 38 with respect to the seat portion 36.

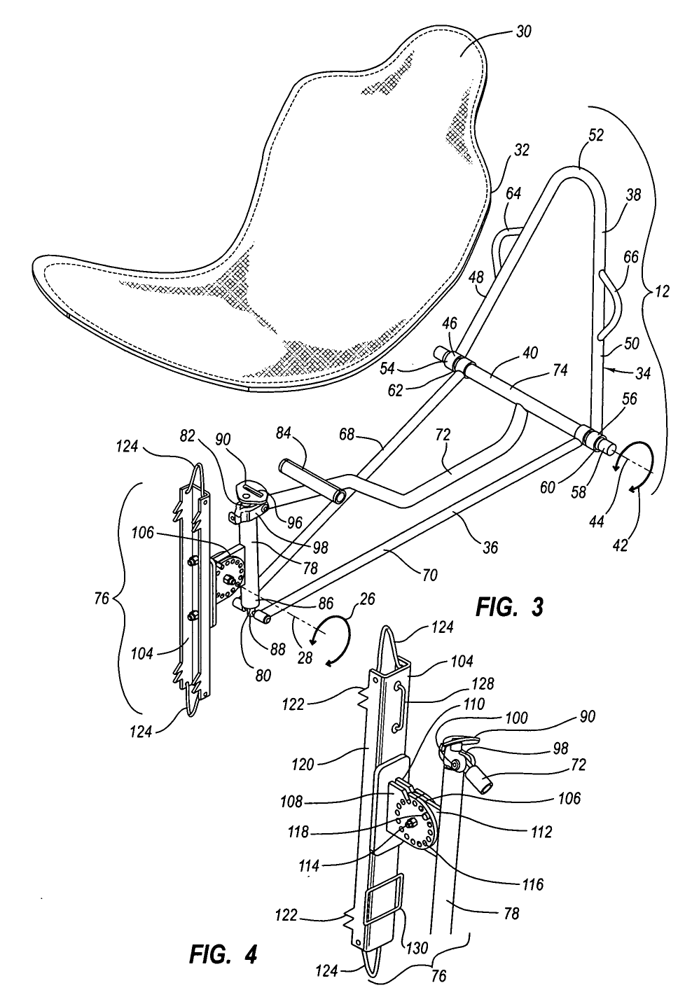

As illustrated in FIG. 3, the back portion 38 has a structure that has an inverted V-shape, rectangular shape, arcuate shape, or other shape known in the art to provide a back rest for a seat. The back portion 38 includes two side members 48, 50 that are connected at an end opposite the third pivot structure 40 with a curved portion 52 between the two side members 48, 50. Each of the side members 48, 50 include a sleeve 54, 56 at an end opposite the curved portion 52. The third pivot structure 40 includes a shaft 58 that is inserted and fixed in each of the sleeves 54, 56 using bushings, bearings 60, 62, or the like to provide the third range of motion 42. Each of the bearings 60, 62 are inserted into a respective sleeve 54, 56 and are arranged to hold the shaft 58 in place. The stop 46 is attached to the sleeves 54, 56 and/or the shaft 58 and arranged to restrict rotational movement between the seat portion 36 and the back portion 38 to place the back portion 38 in an upright arrangement for supporting a user's back.

Handles 64, 66 can be placed on the side members 48, 50 to provide a grip or way to allow the user to grasp the frame 34 and rotate the back portion 38 relative to the seat portion 36. Each of the handles 64, 66 can be attached to a respective side member 48, 50 by an adhesive, fasteners, welding, or the like. For example, each of the handles 64, 66 can be made of a metal bar or tube member that is bent in an arc shape and attached to the side members 48, 50 by welding each of the ends of a handle to one of the side members 48, 50.

The seat portion 36 provides lateral support for a user to sit in the tree stand 10. The seat portion 36 includes two stays 68, 70, a center support member 72, a back member 74, and a front attachment mechanism 76. Each of the stays 68, 70 are arranged along the sides of the tree stand 10 to resist side-to-side sway or torque. One end of the stays 68, 70 is attached to the front attachment mechanism 76 and the other end is attached to the back member 74. The front attachment mechanism 76 includes a pivot weldment 78 that is arranged to run vertically inline with the tree trunk 20. The stays 68, 70 are attached to a lower end 80 of the pivot weldment 78 by a fastener, welding, or otherwise fixing the pieces together.

The center support structure 72 is attached to an upper end 82 of the pivot weldment 78 at one end and the back member 74 at another. The center support structure 72 is curved to attach it to the pivot weldment 78, drop down under the user to provide support in the seat portion 36, and bent up to attach to the back member 74. The center support structure 72 is welded or otherwise fixed to the back member 74. The other end of the center support structure 72 is attached to the pivot weldment 78 using a clamp, fastener, weld, pin, or the like.

A handle 84 can be placed on the center support structure 72 to provide a grip in front of the user. The handle 84 is an optional feature and can be centered on the center support structure 72 next to the pivot weldment 78. The handle 84 is made from a pipe, tube, bar or the like and welded or fastened to the center support structure 72 in a crosswise arrangement to allow the user to grip a side of the handle 84 from each side of the tree stand 10.

The pivot weldment 78 includes a hollow tube 86 and a shaft 88 that passes through the tube 86. The shaft 88 freely rotates within the tube 86 to provide a pivoting action. A buckle or clip 90 is attached to the shaft 88 at the upper end 82 by a fastener, weld, crimp, stamp, or the like. Webbing 92 from a harness or safety straps 94 can be placed around the user and attached to the buckle 90 to anchor the user to the tree stand 10 as shown in FIG. 1. The buckle 90 includes a slot 96 that is sized to fit the webbing 92 through the buckle 90.

A pivot head 98 is attached to the shaft 88 at the upper end 82 below the buckle 90. The pivot head 98 provides a means to attach the center support member 72 to the pivot weldment 78. For example, the center support member 72 can be attached to the pivot head 98 with a pin or fastener 100. A bearing or bushing 102 can be inserted between the pivot head 98 and the tube 86 to assist the user in rotating the tree stand 10 about the pivot weldment 78. The stays 68, 70 are attached to the shaft 88 at the lower end 80 using a pin, fastener, weld, or the like.

The front attachment mechanism 76 also includes a tree mount 104 that is connected to the pivot weldment 78 using a pivot hub 106. The pivot hub 106 is attached between the tree mount 104 and pivot hub 106 using fasteners, welds, or the like, and provides the second range of motion 26. The pivot hub 106 includes a first and second plate 108, 110 on one side of the front attachment mechanism 76 and a third plate 112 attached to the other side. The third plate 112 is attached to the first and second plates 108, 110 using a pivot 114, such as a fastener having a shaft like a bolt or pin that is inserted through a focal point in the plates 108, 110, 112. A series of holes 114 are positioned on a circle around the pivot 112 in each of the first, second, and third plates 108, 110, 112. The holes 114 are arranged to line up with each other so that a pin 118 can be inserted into a hole in the first plate 108, through a hole on the third plate 112, and through a hole in the second plate and fixed in place to restrict the pivot hub 106 from rotating. The outside, or first and second plates 108, 110, can have a single hole while the third plate 112 can have a variety of holes. The pivot 112 provides a point to rotate the tree stand 10 up and down to align it with the tree trunk 20 on the side of the tree mount 104 and to level the seat structure 12 on the other side. When the holes in the plates 108, 110, 112 are aligned and the seat structure 12 in a desired position, the pin 118, such as a cotter pin or bolt and nut, is inserted through the aligned holes and fixed in place.

The tree mount 104 is designed to anchor to the tree trunk 20. The tree mount 104 includes a structural member 120, such as a channel, beam, or the like, and grips 122, such as teeth, pins, hooks, spikes, claws, barbs, or other structures known by one skilled in the art to attach a structure to a tree trunk. The grips 122 are spaced along the structural member 120 and arranged to provide adequate support to hold the tree mount 104 against the tree trunk 20 without slipping down. Spring clips 124 are attached to the top and bottom sides of the structural member 120 to assist the user in attaching and detaching the tree mount 104 to the trunk 20.

Straps 126 are wrapped around the tree trunk 20 and tightened against the tree mount 104 to hold the tree stand 10 in place. The straps 126 can be webbing, rope, or cord with a buckle, clip, or clamp, or other know devices commonly used to tie a device against a tree trunk 20. An upper and lower strap retainer 128, 130 can be used to hold the each of the straps 126 against the tree mount 104. The strap retainers can have various configurations to hold the straps 126 in place. For example, the upper strap retainer 128 can have a C-design, where the ends are attached to the structural member to provide a closed loop so that the webbing can be inserted through the loop by a user. In another example, the lower strap retainer 130 can have a buckle design 130 with a rectangular shape and be sized to fit the width of the webbing and overlap the structural member 120 just enough to provide a gap through the sides of the strap retainer 130 and the structural member 120. The strap retainers 128, 130 can also be cut out and bent up from the structural member 120 or pieces attached to the structural member 120 to provide ridges for the straps 126 to fit between.

A foot rest 132 can be added to the tree stand 10 to help the user rotate the tree stand 10 around the tree trunk 20 or to rest his or her feet while waiting for game to approach. The foot rest 132 can include a strap 134 and a U-structure made of a bar, tube, or beam 136. The U-structure 136 is made to bend around the tree trunk 20, which is held in place with the strap 136. A center strap 138 can be added to provide additional support in the middle of the U-structure 136. The center strap 138 is wrapped around the U-structure 136 and attached to the frame 34 of the tree stand 10.

A storage compartment, container, case, or pocket 140 can be added to the bottom of the frame 34 to store miscellaneous hunting equipment, food, or similar items under the seat structure 12. The storage compartment 140 can be sized to fit under the stays 68, 70 and back member 74. The storage compartment 140 can be opened from the sides using a zipper, snaps, buttons, hook and loop fasteners, or the like. By positioning the storage compartment 140 directly under the seat structure 12, the user can easily reach under the seat while sitting in the tree stand to obtain stored supplies.

The user locates a tree and climbs up to a desired hunting position in the tree. The tree mount 104 is wedged into the tree trunk 20 and the straps are placed around the trunk 20 and tightened or cinched down against the trunk to position the tree stand 10 against the trunk 20 in an upright orientation. For best results, the tree mount 104 is attached to the tree trunk 20 so that the sides of the tree mount 104 are plumb. The front and back of the tree mount 104 do not need to be plumbed because the second pivot structure 18 can be adjusted to account for any curvature in the tree trunk 20. The back portion 38 is then rotated in the third range of motion 42 to place the seat structure 12 in a use position as shown in FIG. 1. The tree stand 10 is then pivoted about the second range of motion 26 to level the seat structure 12 and the pivot hub 106 is locked in position by inserting the pin 118 into the aligned holes 116. The user can shift the cushion 30 over the seat portion to make sure that it is centered before sitting in the tree stand 10. The tree stand is now ready to use. The user can then attach auxiliary devices to the tree stand, such as a safety harness, a foot rest, canopy, and other equipment.

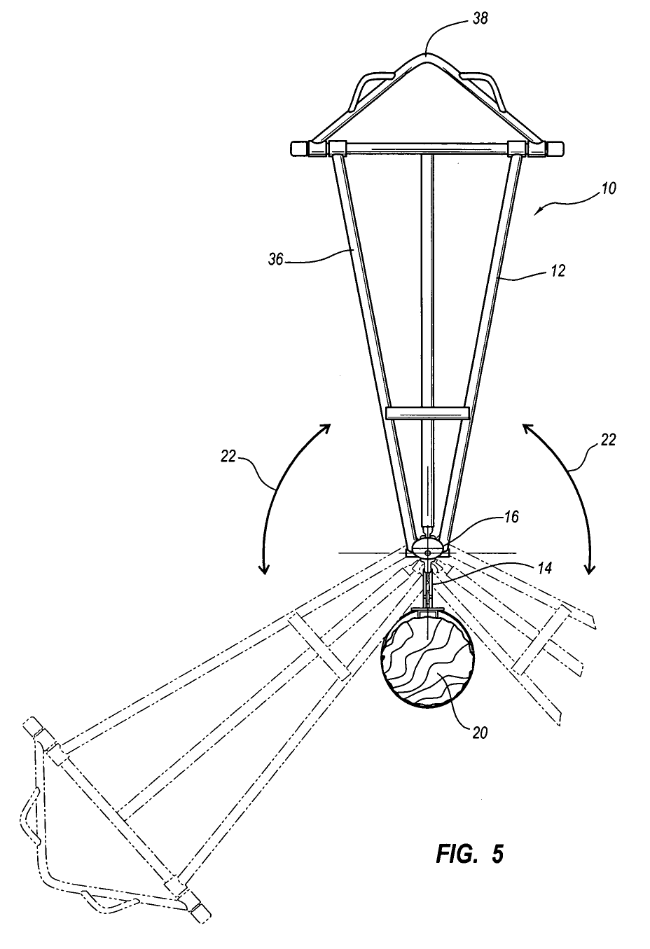

While in the use position, the tree stand 10 can be rotated about the tree trunk 20 as shown in FIG. 5. The tree stand 10 rotates when the user pushes against the tree trunk 20 to pivot the seat structure 12 about the first pivot structure 16 in a first range of motion 22. In this manner, the user can obtain a better view around the tree trunk 20 from each side.

The tree stand 10 is disassembled by folding the back portion 38 down against the seat structure 12 in a third range of motion 42. The attachment device 14 is then removed from the tree trunk 20 by untying the straps 126 and lifting up on the tree mount 104 to disengage the tree stand 10 from the tree. The frame 34 and cushion 30 are then strapped together in a storage position to carry the tree stand 10.

A backpack 142 can be configured from the tree stand 10 components as shown in FIG. 2. For example, shoulder straps 144 can be attached to the cushion 30 or the storage compartment 140 to form a backpack 142. The frame 34 can be positioned between the cushion 30 and the storage compartment 140. If the storage compartment 140 is used to form the backpack 142, the shoulder straps 144 can be attached to the top side of the storage compartment 140 so that when it is assembled against the frame 34, the shoulder straps 144 cannot be seen. In the alternative, the underside of the cushion 30 can be used to fix the shoulder straps 144 to form the backpack 142. The other components can be strapped to the backpack 142 as well to hold all the pieces together.

There are many advantages to the tree stand 10. First, the user can gain more access around the trunk of a tree by rotating the tree stand 10 about a point from one side to the other. This allows the user to get a clear shot from the various points. Also, the user can rotate about a point with very little effort by pushing against the tree trunk with his or her legs. The movement is less likely to create noise when compared with the alternatives, for example, scuffling around in the tree, or climbing up or down the tree trunk to gain better access would likely create enough noise to scare off any approaching game.

Second, the tree stand 10 is versatile. It is made of a light-weight material to allow a user to pack it in almost anywhere. The tree stand 10 can also be attached to trees that are not growing straight or completely vertical. The user can also set up the tree stand and take it down quickly.

Third, the tree stand 10 provides a stable seat for a user and provides access to stored items within arms reach. The user can rotate the seat to a different point while still being able to get a steady shot at game. It is important to restrict movement as much as possible so as to not scare away the game. The tree stand 10 of the present invention provides a variety of positions with a small amount of movement.

While the tree stand 10 has been described with reference to the specific embodiment described, the descriptions are only illustrative and are not to be construed as limiting the invention. As such, the optimal dimensional relationships for the parts of the exemplary embodiment of the invention can be varied in size, materials, shape, configurations, form, function and manner of operation. The optimal dimensional relationships, use and assembly that are readily apparent to those skilled in the art and all equivalent relationships to the embodiments illustrated in the drawings and described in the specification are intended to be encompassed by the present invention. For example, the tree stand, while described as being capable of attaching to a tree trunk, it is also contemplated that the tree stand can be attached to a pole, post, beam, pillar, or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A tree stand for attaching to a tree trunk, the tree stand comprising:
a seat structure shaped to provide support for a user, the seat structure having a frame;
an attachment device configured to anchor to the tree trunk and to support the weight of a user positioned in the tree stand; and
a first pivot structure attached between the seat structure and the attachment device, the first pivot structure being connected to the frame and cantilevered out from the first pivot structure, the first pivot structure having a first axis about which the seat structure rotates through a first range of motion, the first range of motion being side to side movement around the tree trunk.

2. The tree stand of claim 1, further comprising a second pivot structure attached to the tree stand between the seat structure and the attachment device, the second pivot structure having a second axis about which the seat structure rotates through a second range of motion.

3. The tree stand of claim 2, wherein the second axis is substantially perpendicular to the first axis.

4. The tree stand of claim 3, wherein the second pivot structure provides rotational movement to plumb the first axis.

5. The tree stand of claim 2, wherein the seat structure further comprises a seat portion and a back portion, and further comprising a third pivot structure attached between the seat portion and the back portion, the third pivot structure having a third axis about which the back portion rotates through a third range of motion.

6. The tree stand of claim 5, wherein the third axis is substantially parallel to the second axis.

7. The tree stand of claim 5, further comprising at least one handle attached to the back portion.

8. The tree stand of claim 2, wherein the second pivot structure includes first, second, and third plates, and a pivot, the pivot being arranged to connect the plates together at a point, and the third plate being capable of rotating between the first and second plates, the third plate being connected to one of the seat structure and the attachment device, and the first and second plates being connected to the other of the seat structure and the attachment device.

9. The tree stand of claim 8, wherein the first, second, and third plates include holes that can be aligned with each other, and further including a pin that is inserted through the aligned holes.

10. The tree stand of claim 2, wherein the seat structure further comprises a seat portion and a back portion, and further comprising a third pivot structure attached between the seat portion and the back portion, the third pivot structure having a third axis about which the back portion rotates through a third range of-motion.

11. The tree stand of claim 1, wherein the seat structure further comprises a seat portion and a back portion, the back portion being designed to move between a collapsed position and a support position.

12. The tree stand of claim 11, wherein the seat portion includes a center support member and stays positioned on each side of the center support member, the center support member and stays being connected to the first pivot structure.

13. The tree stand of claim 12, wherein the first pivot structure includes an upper end and a lower end, the center support member being connected at the upper end, and each of the stays being connected at the lower end.

14. The tree stand of claim 12, further comprising a handle connected to the center support member and arranged to be positioned in front of a user when the user is sitting in the seat structure.

15. The tree stand of claim 1, wherein the seat structure further comprises a seat portion, a back portion, and a cushion, the cushion being arranged to overlay the seat portion and the back portion.

16. The tree stand of claim 1, wherein the attachment device includes a tree mount, the tree mount having a structural member with grips, the grips being configured to anchor into the tree trunk.

17. The tree stand of claim 16, further comprising straps that are configured to wrap around the tree trunk and hold the tree mount against the tree trunk.

18. The tree stand of claim 17, further comprising at least one strap retainer attached to the structural member, the strap being positioned in the strap retainer.

19. The tree stand of claim 16, further comprising at least one spring clip, the spring clip being attached to an end of the structural member.

20. The tree stand of claim 1, further comprising a foot rest configured to attach to the tree trunk below the seat attachment device, the foot rest being attached to the seat structure with a center strap.

21. The tree stand of claim 1, further comprising a storage compartment attached to the seat structure, the storage compartment being within arms reach while the user is sitting in the seat structure.

22. The tree stand of claim 1, wherein the tree stand is adjustable between a use position and a storage position, the seat structure being collapsible into the storage position.

23. The tree stand of claim 22, further comprising shoulder straps attached to the seat structure and arranged to provide a way for the user to carry the tree stand while the tree stand is in the storage position.

24. A hunter tree stand, comprising:
a seat structure shaped to provide support for a user, the seat structure having a frame, the seat structure being moveable between a use position wherein the user can sit in the seat structure and a storage position wherein the user can tote the tree stand;
an attachment device configured to anchor the tree stand to a tree trunk and to support the weight of the user positioned in the tree stand; and
a first pivot structure attached between the seat structure and the attachment device, the first pivot structure being attached to the frame and having a first axis about which the seat structure rotates through a first range of motion, the first range of motion ranging between a first point where one side of the seat structure touches the tree trunk to a second point where another side of the seat structure touches the tree trunk.

25. The tree stand of claim 24, further comprising a second pivot structure attached to the tree stand between the seat structure and the attachment device, the second pivot structure having a second axis about which the seat structure rotates through a second range of motion.

26. The tree stand of claim 25, wherein the second axis is substantially perpendicular to the first axis.

27. The tree stand of claim 26, wherein the second pivot structure provides rotational movement to plumb the first axis.

28. The tree stand of claim 25, wherein the seat structure further comprises a seat portion and a back portion, and further comprising a third pivot structure attached between the seat portion and the back portion, the third pivot structure having a third axis about which the back portion rotates through a third range of motion between a collapsed position and a support position.

29. The tree stand of claim 28, wherein the third axis is substantially parallel to the second axis.

30. The tree stand of claim 25, wherein the second pivot structure includes first, second, and third plates, and a pivot, the pivot being arranged to connect the plates together at a point, and the third plate being capable of rotating between the first and second plates, the third plate being connected to one of the seat structure and the attachment device, and the first and second plates being connected to the other of the seat structure and the attachment device.

31. The tree stand of claim 30, wherein the first, second, and third plates include holes that can be aligned with each other, and further including a pin that is inserted through the aligned holes.

32. The tree stand of claim 25, wherein the seat structure further comprises a seat portion and a back portion, and further comprising a third pivot structure attached between the seat portion and the back portion, the third pivot structure having a third axis about which the back portion rotates through a third range of motion between the use position and the storage position.

33. The tree stand of claim 24, further comprising shoulder straps attached to the tree stand and arranged to provide a way for the user to carry the tree stand while the tree stand is in the storage position.
